(19) United States
(12) Patent Application Publication
(10) Pub. No.: US 2007/0069103 A1
(43) Pub. Date: Mar. 29, 2007

(54) Isolator/dissipator for interfacing between the ground and supporting structures

(76) Inventor: Marco Ferrari, Trento (IT)

Correspondence Address: Modiano & Associati, Via Meravigli, 16, Milano, 20123, IT

(21) Appl. No.: 10/575,952

(22) PCT Filed: Oct. 25, 2004
(86) PCT No.: PCT/EP04/12022

§ 371 Date: Apr. 13, 2006

(30) Foreign Application Priority Data
Oct. 30, 2003 (IT) VR2003A000126

(51) Int. Cl. F16M 13/00

(52) U.S. Cl. 248/544

(57) ABSTRACT

An isolator/dissipator for interfacing between the ground and supporting structures comprising a supporting base fixable to the ground and supporting a contact base that can be associated, by way of a kinematic connection, with a lower portion of at least one supporting upright of a supporting structure; interface elements being provided between the contact base and the supporting base suitable to allow the contact base to move with respect to the supporting base at least along two directions that are parallel to the ground; and return elements, which act between the contact base and the supporting base and are adapted to control the relative movement between the supporting base and the contact base.

The present invention relates to an isolator/dissipator for interfacing between the ground and supporting structures.

### BACKGROUND OF THE INVENTION

Currently, in regions subjected to seismic events, the statutory provisions currently in force require buildings to have particular constructive solutions, so as to ensure that the structures do not collapse in case of seismic events.

However, no particular attention has been given up to now to devising solutions and constructive refinements that also allow supporting structures such as shelf units and similar devices to withstand seismic events.

A dissipator/isolator for interfacing between the ground and supporting structures, which is designed to prevent the collapse of structures, such as for example industrial shelf units, as a consequence of seismic events, is known from Italian patent application VR2001A000023 by the same Applicant.

Such device, interposed between the ground and the uprights of the shelf unit, is capable of allowing a relative and controlled movement between the uprights and the ground at least on the plane of highest rigidity of the shelf unit, so as to prevent its collapse in case of seismic events.

Although the device described above is a valid solution to the technical problem mentioned above, since it allows to reduce the intrinsic rigidity of the structure, it is not easily applicable if one wishes to achieve multidirectionality of the translational motions between the upright and the ground.

### SUMMARY OF THE INVENTION

The aim of the present invention is to eliminate or at least drastically reduce the drawback noted above.

An object of the present invention is to limit the danger of any goods stored on supporting structures from tipping and at the same time to avoid the collapse of supporting structures, particularly industrial shelf units, as a consequence of seismic events.

Another object of the invention is to allow to provide an isolator/dissipator that has a simple configuration, low production cost and high durability, so as to be competitive also from the economical standpoint.

This aim and these and other objects that will become better apparent hereinafter are achieved by an isolator/dissipator for interfacing between the ground and supporting structures according to the present invention, characterized in that it comprises a supporting base that can be fixed to the ground and supports a contact base that can be associated, by way of kinematic connection means, with a lower portion of a supporting upright of said supporting structures, interface means being provided between the contact base and the supporting base and being adapted to allow the contact base to move with respect to the supporting base at least along two directions that lie on a plane that is substantially parallel to the supporting base, return means being provided which are adapted to control the relative movement between the contact base and the supporting base, said return means acting between said supporting base and said contact base.

Advantageously, in an isolator/dissipator according to the present invention the interface means are adaptable to allow the contact base to move on a plane that is substantially parallel to the ground.

Conveniently, in an isolator/dissipator according to the invention the interface means comprise a plurality of balls that rest on the supporting base and support the contact base.

### BRIEF DESCRIPTION OF THE DRAWINGS

Further characteristics and advantages of the invention will become better apparent from the description of some preferred but not exclusive embodiments of an isolator/dissipator according to the invention, illustrated by way of non-limiting example in the accompanying drawings, wherein:

FIG. 1 is a partial side elevation view of two supporting uprights of a shelf unit, associated with an isolator/dissipator according to the invention;

FIG. 2 is a sectional view of one of the supporting uprights, taken along the line II-II of FIG. 1;

FIG. 3 is a sectional view of the same body, taken along the line III-III of FIG. 2;

FIG. 4 is a sectional view, taken along the line IV-IV of FIG. 3;

FIG. 5 is a top elevation view of the interface means;

FIG. 6 is a sectional view of the interface means, taken along the line VI-VI of FIG. 5;

FIG. 7 is a top elevation view of a further embodiment of the interface means shown in FIGS. 5 and 6;

FIG. 8 is a sectional view, taken along the line VIII-VIII of FIG. 7, of the interface means according to a further embodiment;

FIG. 9 is a top elevation view of the contact base, in which a portion has been omitted for the sake of greater clarity;

FIG. 10 is a view, similar to FIG. 9, of another embodiment of the interface means; and

FIG. 11 is an exploded perspective view of an example of still another embodiment of the isolator/dissipator.

### DESCRIPTION OF THE PREFERRED EMBODIMENTS

In the embodiments described in the following, individual characteristics, given in relation to specific examples, may actually be interchanged with other different characteristics that exist in other examples of embodiments.

With reference to the figures, an isolator/dissipator according to the present invention, generally designated by the reference numeral 1, comprises a supporting base 3, generally constituted by a plate-like element, which is designed to be fixed to a ground 100 by way of per se known fixing means, such as for example mechanical anchoring elements 4 (such as screw anchors) and/or chemical ones (such as resin and a threaded bar).

During use, a contact base 5 is arranged above the supporting base 3 and can be associated, by way of kinematic connecting means 6, with a lower portion 2a of a respective supporting upright 2 of a supporting structure 20, such as for example an industrial shelf unit.

More particularly, between the supporting base 3 and the contact base 5 there are interposed interface means 7, which are adapted to allow the contact base 5 to move with respect to the supporting base 3 and therefore with respect to the ground 100 along at least two directions that lie on a plane that is substantially parallel to the ground 100.

Advantageously, the interface means 7 allow the contact base 5 to move in all directions on the plane that is substantially parallel to the ground 100.

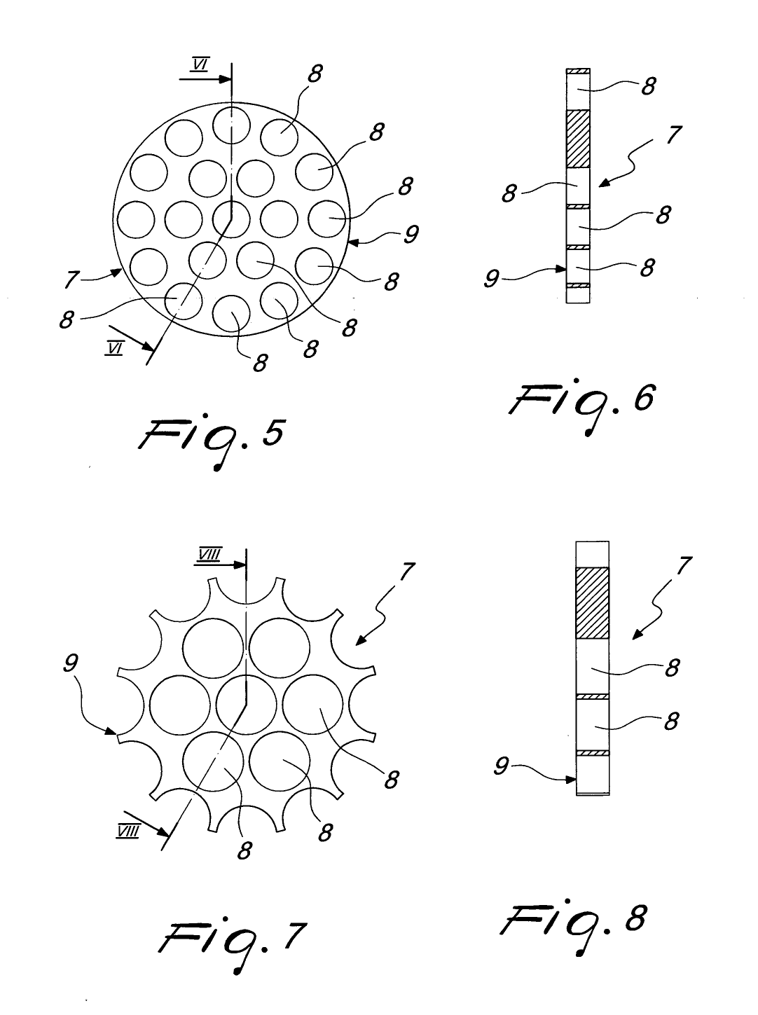

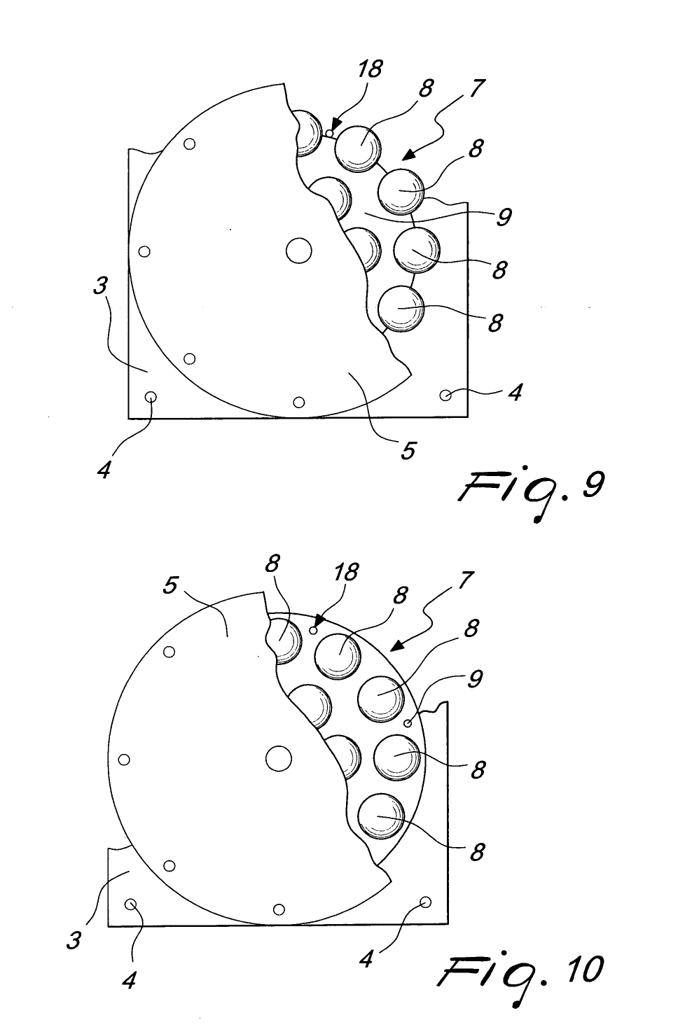

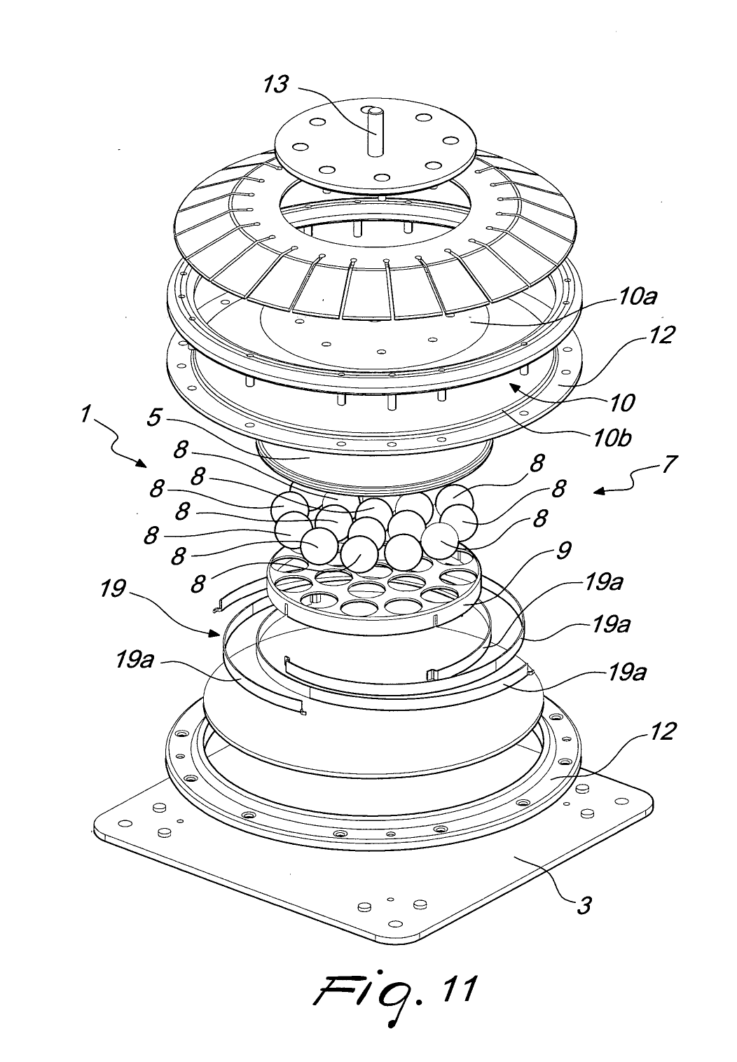

A first exemplifying example of interface means 7 capable of ensuring this behavior is shown in the figures cited above. In greater detail, the illustrated interface means 7 comprise a plurality of balls 8, which rest on the surface of the supporting base 3 that is directed upwardly during use and in turn support the contact base 5. Advantageously, the interface means 7 further comprise a framework 9 (which can be variously shaped, as clearly shown in the embodiments shown in FIGS. 5 to 10), which is adapted to keep the balls 8 spaced from each other.

Conveniently, the framework 9 is provided with means that are adapted to retain the balls 8 and therefore prevent them from leaving their respective seat during the movement of the isolator/dissipator 1 or during use.

As an alternative, the interface means 7 can also be provided by using sheets that have a low friction coefficient, such as sheets made of PTFE, Polizene, et cetera.

According to the present invention, return means are provided which are adapted to control the movement or movements of the contact base 5 with respect to the supporting base 3 and accordingly with respect to the ground 100 in order to return the contact base 5 to the condition that preceded the dynamic stresses (such as for example stresses caused by an earthquake).

In particular, such return means can be constituted by control means 10, which act between the contact base 5 and the supporting base 3.

The control means 10 can be constituted by various known devices, which are capable of applying, in case of relative movement between the contact base 5 and the supporting base 3, a return force that tends to return the contact base 5 to the initial position (in practice, to the position that preceded the dynamic action). In particular, said control means 10 can have, if they are subjected to specific stresses caused by relative movement between the supporting base 3 and the contact base 5, a substantially elastic behavior, but can also have an elastoplastic, viscoelastic or viscoelastoplastic behavior.

The position of the control means 10 with respect to the vertical load transmitted to the contact base 5 by the respective upright 2 is an important aspect of the isolator/dissipator 1.

Conveniently, the control means 10 are in fact arranged in such a position that they do not have to withstand the vertical loads transmitted by the upright 2 to the ground 100, since such loads act, in static conditions as well as in dynamic conditions, on the interface means 7 and therefore directly onto the supporting base 3.

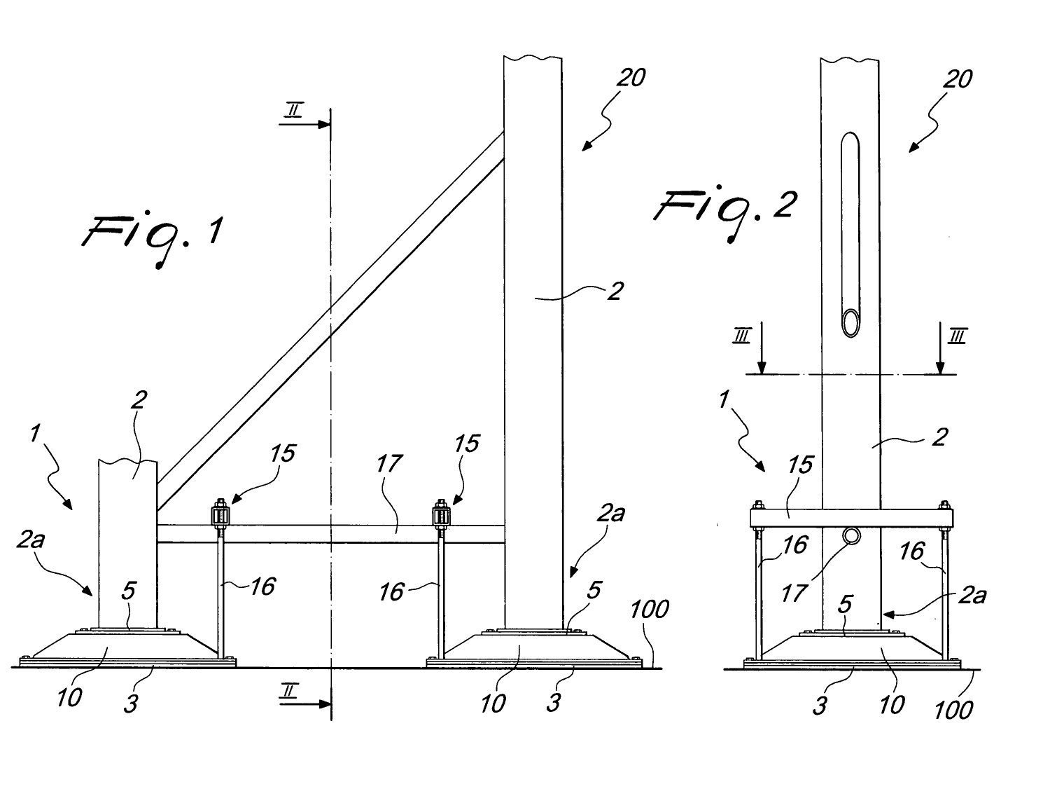

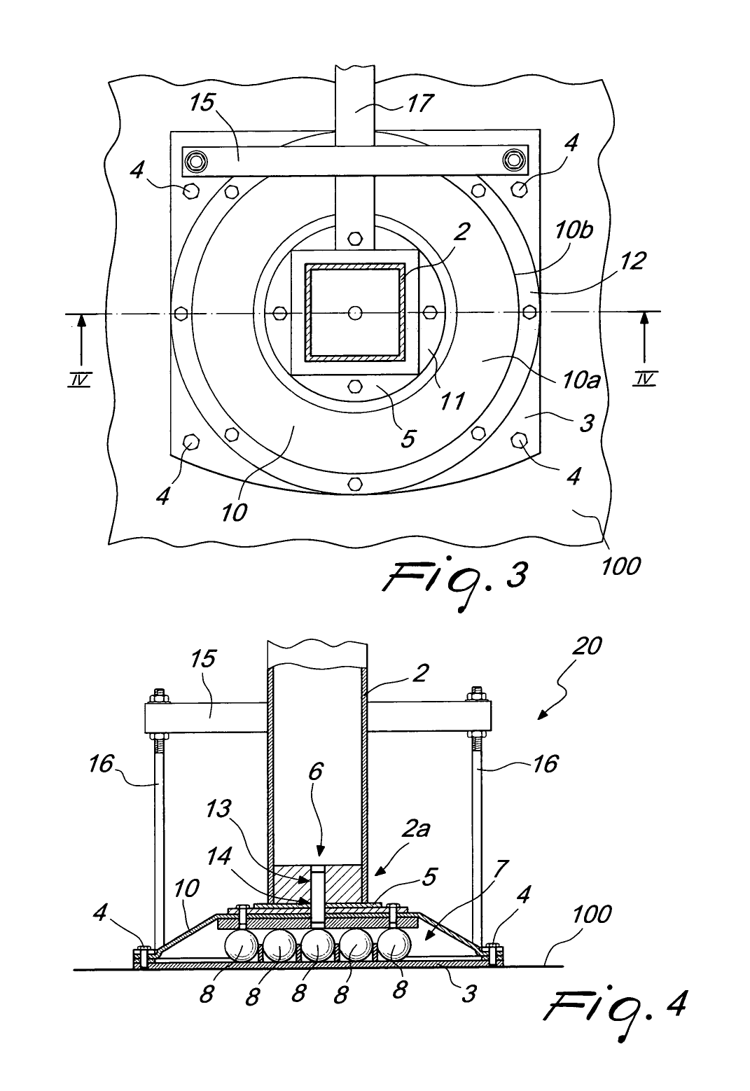

In greater detail, and with particular reference to FIGS. 1 to 4, said control means 10 can be constituted by an element that is substantially annular (or disc-like) and has a first edge 10a, which has a smaller diameter (or central core), which can be fixed to the contact base 5 for example by means of a first annular locking element (or ring) 11, and a second, outer edge, 10b, which can be anchored to the supporting base 3 by means of a second locking element (or ring) 12 (or by entirely equivalent means).

As regards the annular (or disc-like) element, it has been found that it is suitable to use para rubber or silicone sheets that are optionally pre-tensioned but also to use rubber sheets, such as sheets based on styrene rubber, natural rubber, styrene and polybutadiene rubber, nitrile rubber, chloroprene rubber (Neoprene), ethylene propylene rubber (EPDM), fluoridized rubber, silicone rubber and natural and chloroprene rubber. Moreover, it is possible to use a plurality of sheets having different mechanical characteristics.

Advantageously, the control means 10 may extend from the contact base 5 to the outermost portion of the supporting base 3, so as to constitute a frustum-shaped element that on the one hand ensures control of the contact base 5 and on the other ensures continuous contact between the balls 8 that are part of the interface means 7, the supporting base 3 and the contact base 5.

In a fully equivalent manner, the control means 10 may of course be constituted by a plurality of elements having an elastic behavior, such as for example elastic elements or springs, but also having an elastoplastic, viscoelastic, or viscoelastoplastic behavior, which are arranged radially; these elements can advantageously act as connections between the contact base 5 and the supporting base 3.

With particular reference to the illustrated example of embodiment, it can be noted that the particular configuration of the control means 10 allows to move the contact base 5 even beyond the outer edge of the supporting base 3. This characteristic on the one hand allows great movements of the contact base 5 during dynamic action and on the other allows to contain the dimensions of the isolator/dissipator 1 in inactive conditions.

With particular reference to the cross-section shown in FIG. 4, it can be seen that according to a preferred embodiment the kinematic connection means 6 can be constituted by a pin 13, which protrudes from the surface of the contact base 5 that is arranged upwardly during use in a substantially vertical direction, and by an engagement seat 14 for the pin 13, which is formed at the lower portion 2a of the respectively supporting upright 2; conveniently, said engagement seat 14 can be constituted by a hole provided in the foot of the supporting upright 2.

It is evident that the use of said kinematic connecting means 6 allows to avoid the transfer of vertical forces that are directed upwardly, from the supporting upright 2 to the contact base 5.

If the contact base 5 is subjected, during any horizontal movement (caused by seismic event but also by impact with a fork-lift truck, for example), to a force that is directed upwardly, such force might cause loss of contact between the contact base 5 and the interface means 7, with loss of control of their motion.

Accordingly, it is highly advantageous to provide the isolator/dissipator with the above described kinematic connecting means 6.

In this regard, it is convenient to provide the isolator/dissipator 1 with means for locking each supporting upright 2 to the respective supporting base 3 with respect to upward vertical movements.

In particular, according to a preferred embodiment, said locking means can be constituted advantageously by a locking cross-member 15, which is supported by at least one vertical shoulder 16 and is arranged, during use, above an abutment element 17, which is constituted for example by a spacer for connecting two supporting uprights 2.

Conveniently, as shown in the figures cited above, the locking cross-member 15 is supported by two vertical shoulders 16, which are arranged on opposite sides with respect to the abutment element 17.

Advantageously, the contact base 5 can be obtained by superimposing two disc-like elements wherebetween a portion (particularly the first edge or core 10a) of the control means 10 is interposed. In this particular case, the disc-like elements can be rigidly coupled by screws: the friction generated between the parts in contact (the discs and the control means) allows to provide the coupling required to allow the control means 10 to control the movements of the contact base 5.

According to a particular aspect of the present invention, means 19 for central positioning and centering of the framework 9 and therefore of the balls 8 are provided.

Conveniently, such central positioning and centering means 19 can be provided by means of a plurality of spring-loaded centering elements 19a, which are interposed between the framework 9 and the second locking element (or ring) 12.

As an alternative, the isolator/dissipator 1 can be provided with at least one element 18 for connecting the contact base 5, the interface means 7 and optionally the supporting base 3: such connecting element 18 is useful for the initial positioning (centering) of the interface means 7 and is removed at the end of the operations for assembling the supporting structure 20.

In greater detail, it is possible to use, as a connecting element 18, two centering pins, which are designed to pass through centering openings or holes provided in the contact base 5 and optionally in the interface means 7 and/or in the supporting base 3.

Operation of the isolator/dissipator 1 according to the present invention is evident from what has been described above.

In particular, if the surface (ground 100) on which the supporting structure 20 is located is subjected to a dynamic action (for example a seismic event), the movements of the ground 100, and therefore of the supporting base 3, activate the interface means 7 (in practice the balls 8), which are designed to isolate the supporting structure 20 from the ground 100.

The movement of the supporting base 3 is responsible for a slight transfer of forces to the supporting structure 20, caused by friction between the moving parts and by deformation of the control means 10, which are designed to stabilize the supporting structure 20 in the inactive condition (before the seismic event) and to control relative movement between the supporting base 3 and the contact base 5 during the seismic event.

During the relative movement between the supporting base 3 and the contact base 5, the control means 10 change their rigidity; this particularity allows to limit the onset of dangerous resonance phenomena.

In practice, by undergoing deformation, the control means 10 change their geometry and their ability to react to the forces applied; interaction between the change in geometry and the change in the ability to react to the applied forces allows to obtain a number of changes in the value of rigidity during the relative movement between the supporting base 3 and the contact base 5.

In particular, according to the illustrated embodiment described above, the invention is capable of having a behavior that is isotropic with respect to the initial inactive position (before a seismic event).

All the characteristics of the invention that have been described above as advantageous, convenient or the like may also be omitted or be replaced with equivalents.

The invention thus conceived is susceptible of numerous modifications and variations, all of which are within the scope of the appended claims.

Thus, for example, it is possible to provide, optionally in association with the control means 10, other devices for controlling the response to the seismic event, such as systems that use Newtonian and non-Newtonian fluids (Bingham plastics, pseudoplastic substances, dilatant fluids, thixotropic substances, antithixotropic substances, viscoelastic fluids, et cetera).

In this regard, it is possible to insert a silicone substance or the like between the balls 8 so as to obtain a viscoelastic behavior.

According to another embodiment, the control means 10 can comprise a toroidal element that has an elastic or elastoplastic or viscoelastic or viscoelastoplastic behavior and is interposed between the contact base 5 and an abutment shoulder that rises from the supporting base 3.

In practice it has been observed that the invention, in all its embodiments, has achieved the intended aim and objects.

Moreover, it has been observed that the radial arrangement of the control means 10 allows automatic modification of the rigidity of the isolator/dissipator 1, accordingly limiting dangerous resonance phenomena.

Another important aspect of the present invention is that the particular configuration of the control means 10 allows to protect the interface means 7 from penetration of foreign objects (for example dust).

Moreover, it has been observed that an isolator/dissipator according to the present invention can also be used in different fields of application, such as for example the seismic protection of components and systems for the building sector.

Anything found to be already known in the art will be the subject of a proper disclaimer.

In practice, the materials used, so long as they are compatible with the contingent use, as well as the shapes and dimensions, may be any according to requirements.

All the details may further be replaced with other technically equivalent elements.

The disclosures in Italian Patent Application No. VR2003A000126 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs. a toroidal element that has an elastic or elastoplastic or viscoelastic or viscoelastoplastic behavior and is interposed between the contact base 5 and an abutment shoulder that rises from the supporting base 3.

In practice it has been observed that the invention, in all its embodiments, has achieved the intended aim and objects.

Moreover, it has been observed that the radial arrangement of the control means 10 allows automatic modification of the rigidity of the isolator/dissipator 1, accordingly limiting dangerous resonance phenomena.

Another important aspect of the present invention is that the particular configuration of the control means 10 allows to protect the interface means 7 from penetration of foreign objects (for example dust).

Moreover, it has been observed that an isolator/dissipator according to the present invention can also be used in different fields of application, such as for example the seismic protection of components and systems for the building sector.

Anything found to be already known in the art will be the subject of a proper disclaimer.

In practice, the materials used, so long as they are compatible with the contingent use, as well as the shapes and dimensions, may be any according to requirements.

All the details may further be replaced with other technically equivalent elements.

The disclosures in Italian Patent Application No. VR2003A000126 from which this application claims priority are incorporated herein by reference.

What is claimed is:

1-34. (canceled)

35. An isolator/dissipator for interfacing between the ground and supporting structures, comprising a supporting base that can be fixed to the ground and supports a contact base that can be associated, by way of kinematic connection means, with a lower portion of at least one supporting upright of a supporting structure, interface means being provided between said contact base and said supporting base and being adapted to allow said contact base to move with respect to said supporting base at least along two directions that are parallel to the ground, return means being provided which are adapted to control the relative movement between said contact base and said supporting base, said return means acting between said supporting base and said contact base.

36. The isolator/dissipator according to claim 35, wherein said return means comprise control means for controlling the movement of said contact base with respect to said supporting base, said control means having a behavior that is substantially at least elastic.

37. The isolator/dissipator according to claim 36, wherein said control means substantially have an elastoplastic behavior.

38. The isolator/dissipator according to claim 36, wherein said control means have a substantially viscoelastic behavior.

39. The isolator/dissipator according to claim 36, wherein said control means have a substantially viscoelastoplastic behavior.

40. The isolator/dissipator according to claim 35, wherein said interface means are adapted to allow the movement of said contact base on a plane that is substantially parallel to the ground.

41. The isolator/dissipator according to claim 40, wherein said interface means comprise a plurality of balls, which rest on said supporting base and support said contact base.

42. The isolator/dissipator according to claim 41, wherein said a plurality of balls are kept spaced from each other by way of a framework.

43. The isolator/dissipator according to claim 42, wherein said framework comprises means that are adapted to retain the balls.

44. The isolator/dissipator according to claim 40, wherein said interface means comprise a sheet with a low friction coefficient.

45. The isolator/dissipator according to claim 44, wherein said sheet having a low friction coefficient is made of PTFE or Polizene.

46. The isolator/dissipator according to claim 36, wherein said control means comprise at least one substantially annular element, which has a first edge that can be fixed to said contact base and a second edge that can be fixed to said supporting base.

47. The isolator/dissipator according to claim 36, wherein said control means comprise at least one substantially disc-like element, which has a central core that can be fixed to said contact base and a second edge that can be fixed to said supporting base.

48. The isolator/dissipator according to claim 36, wherein said control means comprise a para rubber sheet or a silicone sheet.

49. The isolator/dissipator according to claim 36, wherein said control means comprise a sheet made of rubber, such as for example a sheet made from a rubber selected from the group containing styrene rubber, natural rubber, styrene and polybutadiene rubber, nitrile rubber, chloroprene rubber (Neoprene), ethylene propylene rubber (EPDM), fluoridized rubber, silicone rubber and natural and chloroprene rubber.

50. The isolator/dissipator according to claim 48, wherein said para rubber sheet or said silicone sheet is pre-tensioned.

51. The isolator/dissipator according to claim 49, wherein said sheets made of any of styrene rubber, natural rubber, styrene and polybutadiene rubber, nitrile rubber, chloroprene rubber (neoprene), ethylene propylene rubber (EPDM), fluoridized rubber, silicone rubber and natural and chloroprene rubber are provided pre-tensioned.

52. The isolator/dissipator according to claim 36, wherein said control means comprise a plurality of connection elements for connecting said supporting base and said contact base.

53. The isolator/dissipator according to claim 52, wherein said connection elements are arranged radially.

54. The isolator/dissipator according to claim 52, wherein said connection elements have an elastic or elastoplastic or viscoelastic or viscoelastoplastic behavior.

55. The isolator/dissipator according to claim 54, wherein said connection elements comprise a plurality of elastic components or a plurality of springs.

56. The isolator/dissipator according to claim 35, wherein said kinematic connecting means comprise a pin that protrudes from said contact base substantially at right angles to said contact base, and an engagement seat for said pin, which is formed at said lower portion of said at least one supporting upright.

57. The isolator/dissipator according to claim 56, further comprising locking means for locking said at least one supporting upright to said supporting base.

58. The isolator/dissipator according to claim 57, wherein said locking means comprise a locking cross-member which is parallel to the ground during use and can be fixed to at least one shoulder that protrudes from said supporting base and is arranged above an abutment element supported by said at least one supporting upright.

59. The isolator/dissipator according to claim 46, further comprising a first ring for fixing said substantially annular element to said contact base and a second ring for fixing said substantially annular element to said supporting base.

60. The isolator/dissipator according to claim 59, further comprising positioning and centering means for the central positioning and centering of said interface means.

61. The isolator/dissipator according to claim 60, wherein said initial positioning and centering means comprise a plurality of spring-type centering elements, which are interposed between said framework and said second fixing ring.

62. The isolator/dissipator according to claim 35, further comprising at least one connecting element for connection between said contact base and said interface means for the initial positioning of said interface means.

63. The isolator/dissipator according to claim 62, wherein said connecting element can engage said supporting base.

64. The isolator/dissipator according to claim 63, wherein said at least one connecting element comprises at least one centering pin engageable within respective centering openings provided in said contact base, in said interface means and/or in said supporting base.

65. The isolator/dissipator according to claim 36, wherein said control means comprise a toroidal element that has an elastic or elastoplastic or viscoelastic or viscoelastoplastic behavior and is interposed between said contact base and an abutment shoulder that rises from said supporting base.

66. The isolator/dissipator according to claim 36, wherein said control means comprise at least one response control device, which comprises fluid elements of the Newtonian type or of the non-Newtonian type associated with said interface means.

67. The isolator/dissipator according to claim 35, wherein said supporting upright is adapted to support at least one shelf of an industrial shelf unit.

68. The isolator/dissipator according to claim 35, associated with a component or a system of components for the building sector.
